(19) United States
(12) Patent Application Publication
(10) Pub. No.: US 2017/0349027 A1
(43) Pub. Date: Dec. 7, 2017

(54) SYSTEM FOR CONTROLLING VEHICLE CLIMATE OF AN AUTONOMOUS VEHICLE SOCIALLY

(71) Applicant: GM Global Technology Operations LLC, Detroit, MI (US)

(72) Inventors: Claudia V. Goldman-Shenhar, MEVASSERET ZION (IL); Gila Kamhi, ZICHRON YAAKOV (IL)

(21) Appl. No.: 15/605,405

(22) Filed: May 25, 2017

Related U.S. Application Data
(60) Provisional application No. 62/344,603, filed on Jun. 2, 2016.

(51) Int. Cl. B60H 1/00; G05D 1/00; G06F 17/30

(52) U.S. Cl. CPC B60H 1/00742; G06F 17/30699; G05D 1/0088; B60H 1/0075; B60H 1/00757; B60H 1/00785

(57) ABSTRACT

A system, for controlling socially one or more climate-affecting vehicle devices, such as for use with an autonomous vehicle. The system includes a non-transitory computer-readable storage component comprising an interface module that, when executed by a hardware-based processing unit, obtains a ride-sharer passenger profile for each of multiple passengers of an autonomous vehicle. The hardware-based processing unit is part of the system in various embodiments. The storage component includes a social vehicle-climate-manager module that, when executed by the hardware-based processing unit, determines group climate parameters for the autonomous vehicle based on the ride-sharer profiles. And the storage component includes an output module that, when executed by the hardware-based processing unit, controls the autonomous-vehicle climate-affecting devices based on the group climate parameters determined.

### TECHNICAL FIELD

The present disclosure relates generally to vehicle climate control and, more particularly, to systems for regulating climate control socially, based on preferences and communications of ride-sharing passengers of vehicles, such as an autonomous vehicles.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace in the near future, a market for fully-autonomous taxi services and shared vehicles is developing. In addition to becoming familiar with the automated functionality, customers interested in these services will need to become accustomed to be driven by a driverless vehicle that is not theirs, and in some cases along with other passengers, whom they may not know.

Uneasiness with automated-driving functionality, and possibly also with the shared-vehicle experience, can lead to reduced use of the autonomous driving capabilities, such as by the user not engaging, or disengaging, autonomous-driving operation, or not commencing or continuing in a shared-vehicle ride. In some cases, the user continues to use the autonomous functions, whether in a shared vehicle, but with a relatively low level of satisfaction.

An uncomfortable user may also be less likely to order the shared vehicle experience in the first place, or to learn about and use more-advanced autonomous-driving capabilities, whether in a shared ride or otherwise.

Levels of adoption can also affect marketing and sales of autonomous-driving-capable vehicles. As users' trust in autonomous-driving systems and shared-automated vehicles increases, the users are more likely to purchase an autonomous-driving-capable vehicle, schedule an automated taxi, share an automated vehicle, model doing the same for others, or expressly recommend that others do the same.

An important aspect of vehicle passenger comfort is vehicle climate.

### SUMMARY

The present technology solves prior challenges to increasing vehicle passenger comfort, and making their ride experience easier, in an automated, socially manner, using passenger preferences and communications.

The term social refers in various embodiments to the functions of the system relating to more than one person. The term may also relate to embodiments in which the system is configured to interact with one or more passengers, prior to, during, or after a ride, for obtaining information to use in controlling climate during a present or future passenger ride.

In one aspect, the present technology relates to a system, for controlling socially one or more vehicle climate devices, such as autonomous-vehicle climate-affecting devices. The system includes a non-transitory computer-readable storage component comprising an interface module that, when executed by a hardware-based processing unit, which may be part of the system, obtains a ride-sharer passenger profile for each of multiple passengers of an autonomous vehicle. The storage component includes a social vehicle-climate-manager module that, when executed by the hardware-based processing unit, determines group climate parameters for the autonomous vehicle based on the ride-sharer profiles. And the storage component includes an output module that, when executed by the hardware-based processing unit, controls the autonomous-vehicle climate-affecting devices based on the group climate parameters determined.

In various embodiments, the autonomous-vehicle climate-affecting devices include a heating, ventilating, and air-conditioning (HVAC) module.

In various embodiments, the output module comprises an HVAC control module to control vehicle HVAC components.

In various embodiments, the autonomous-vehicle climate-affecting devices comprise an ancillary climate-functions device, not including a vehicle heating, ventilating, and air-conditioning (HVAC) apparatus; and the output module comprises an ancillary climate-functions module to control ancillary vehicle device affecting vehicle climate, respectively.

In various embodiments, the interface module receives climate data, and the vehicle-climate-manager module is configured to, when executed by the hardware-based processing unit, determine the group climate parameters for the autonomous vehicle based on the ride-sharer profiles and the climate data.

The climate data may include an intra-vehicle climate condition or an exterior climate condition.

The non-transitory computer-readable storage component may include a passenger-profile learning module that, when executed, generates, based on user-behavior data, learned passenger-profile data regarding at least one passenger, and the ride-sharer profile corresponding to the at least one passenger includes the learned passenger-profile data corresponding to the at least one passenger.

In various embodiments, the interface module, when executed by the hardware-based processing unit, receives a real-time request to change vehicle climate settings from one of the passengers of the autonomous vehicle; and the social vehicle-climate-manager module, when executed by the hardware-based processing unit, determines the group climate parameters for the autonomous vehicle based on the shared-ride profiles and the real-time request.

In various embodiments, at least one of the shared-ride profiles comprises compromise parameters for use in determining the group climate parameters.

In various embodiments, the social vehicle-climate-manager module comprises a voting algorithm or a weighted-sum algorithm; and the social vehicle-climate-manager module, when executed by the hardware-based processing unit, determines the group climate parameters for the autonomous vehicle using the voting algorithm or a weighted-sum algorithm.

In various embodiments, the interface module, when executed by the hardware-based processing unit, receives at least one of the shared-ride profiles from a remote server.

In various embodiments, the system includes one or more climate-affecting components, such as an HVAC apparatus, adjustable vehicle windows, adjustable vehicle sunroof, etc.

In another aspect, the present technology relates to a system, for social climate control during ride-sharing at an autonomous vehicle, including a hardware-based processing unit and a non-transitory computer-readable storage component. The storage component includes a passenger-interface module that, when executed by the hardware-based processing unit, obtains a ride-sharer profile for each of multiple passengers of the autonomous vehicle.

The storage component also includes a vehicle-climate-manager module that, when executed by the hardware-based processing unit, determines a set of group climate parameters for the autonomous vehicle based on the ride-sharer profiles.

In various embodiments, the passenger-interface module, when executed by the hardware-based processing unit, receives a real-time request to change vehicle climate settings from one of the passengers of the autonomous vehicle. And the vehicle-climate-manager module, when executed by the hardware-based processing unit, determines the set of group climate parameters for the autonomous vehicle based on the shared-rider, or shared-ride passenger, profiles and the real-time request.

The modules may include a passenger-profile learning module that, when executed by the processing unit, generates, based on activity of a subject passenger of the passengers, learned data indicating a climate-related preference or activity of one of the multiple passengers of the autonomous vehicle. And the learned data may be considered by the vehicle-climate-manager, as part of the ride-sharer profiles or otherwise.

In various embodiments, the ride-sharer profile for each passenger of the multiple passengers of the autonomous vehicle includes climate-related preferences. And the ride-sharer profile for each passenger of the multiple passengers of the autonomous vehicle can also include compromise, or flexibility, parameters.

In various embodiments, the modules include an HVAC-output module that, when executed, sets vehicle HVAC parameters at the autonomous vehicle according to the set of group climate parameters determined.

The modules in some implementations include an ancillary climate-functions module that, when executed, sets non-HVAC parameters of the autonomous vehicle that affect vehicle climate for at least one of the passengers. And the non-HVAC parameters may include at least one of a window-positioning parameter, a moon-roof-positioning parameter, and a seat-temperature parameter.

In some embodiments, the vehicle-climate-manager module, when executed by the hardware-based processing unit, determines the set of group climate parameters for the autonomous vehicle, based on the ride-sharer profiles, according to a weighted-sum method, a voting method, or any other coordination or conflict solving algorithm.

The technology in various other aspects includes the non-transitory computer-readable storage component according to any of the embodiments described above, or algorithms for performing the functions claimed above or processes including the functions performed by the structure mentioned herein.

Other aspects of the present technology will be in part apparent and in part pointed out hereinafter.

### DESCRIPTION OF THE DRAWINGS

FIG. 1 illustrates schematically an example vehicle of transportation, including a hardware-based controller, with local and remote computing devices, according to embodiments of the present technology.

FIG. 2 illustrates schematically more details of the hardware-based controller of FIG. 1, with the local and remote computing devices.

FIG. 3 shows another view of the vehicle, emphasizing example memory components.

FIG. 4 shows interactions between the various components of FIG. 3, including with external systems.

The figures are not necessarily to scale and some features may be exaggerated or minimized, such as to show details of particular components.

The invention, including that represented by the claims, is not limited to the example illustrations of the figures.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

When a group of co-passengers share a ride, such as in an autonomous-vehicle, the passengers likely have various preferences for the climate in the vehicle. There is need to determine best climate settings for the group, including dealing with potential conflicts amongst various passenger preferences.

The present disclosure describes, by various embodiments, systems for regulating climate control socially, based on preferences of each of multiple passengers sharing the autonomous ride.

While select examples of the present technology presented describe transportation vehicles and, particularly, automobiles, the technology is not limited by the focus. The concepts can be extended to a wide variety of systems and devices, such as other transportation or moving vehicles including aircraft, watercraft, trucks, busses, trains, trolleys, the like, and other, and non-transportation systems.

And while select examples of the present technology presented describe autonomous vehicles, the technology is not limited to use in autonomous vehicles—fully or partially autonomous, or to times in which an autonomous-capable vehicle is being driven autonomously.

References herein to characteristics of a passenger, and communications provided for receipt by a passenger, for instance, should be considered to disclose analogous implementations regarding a vehicle driver during manual vehicle operation. During fully autonomous driving, the ‘driver’ may be considered a passenger.

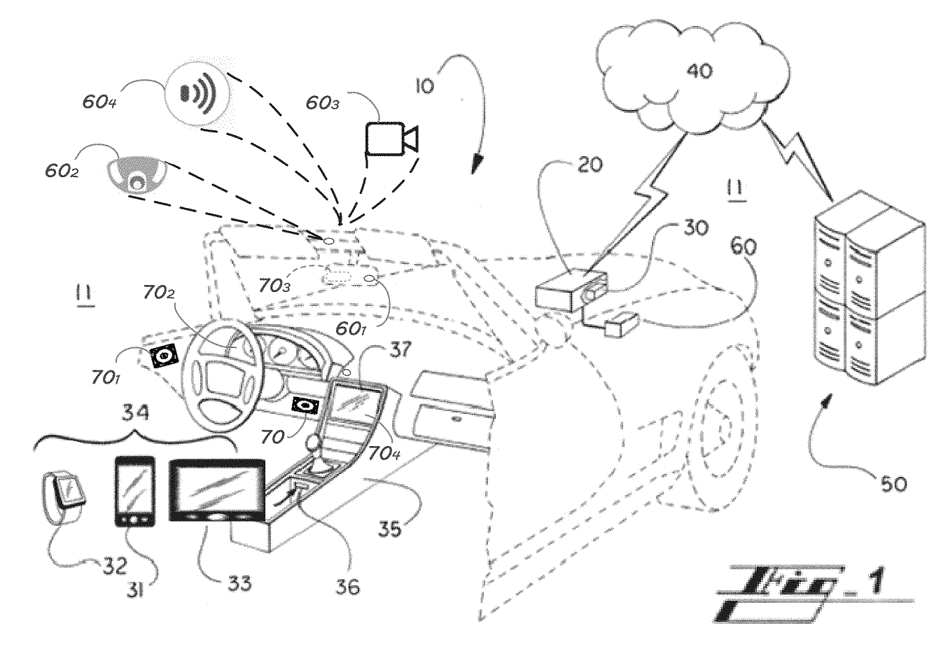

### II. Host Vehicle—FIG. 1

Turning now to the figures and more particularly to the first figure, FIG. 1 shows an example host structure or apparatus 10 in the form of a vehicle and, more particularly, an automobile.

The vehicle 10 includes a hardware-based controller or controller system 20. The hardware-based controller system 20 includes a communication sub-system 30 for communicating with potable or local computing devices 34 and/or external networks 40.

Example networks include the Internet, a local-area, cellular, or satellite network, vehicle-to-vehicle, pedestrian-to-vehicle or other infrastructure communications, etc. By the external networks 40, the vehicle 10 can reach mobile or local systems 34 or remote systems 50, such as remote servers.

Example local devices 34 include a user smartphone 31, a user-wearable device 32, such as the illustrated smart eye glasses, and a tablet 33, and are not limited to these examples. Other example wearables 32 include a smart watch, smart apparel, such as a shirt or belt, an accessory such as arm strap, or smart jewelry, such as earrings, necklaces, and lanyards.

Another example local device 34 is a user plug-in device, such as a USB mass storage device, or such a device configured to communicate wirelessly.

Still another example local device 34 is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

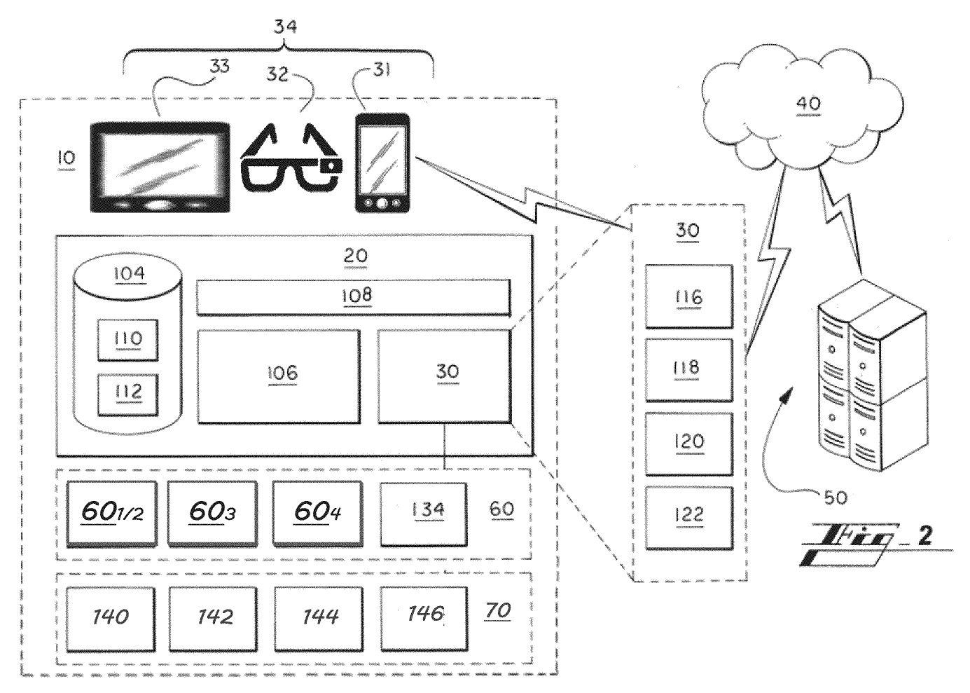

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄. Intra-vehicle-focused sensors 60₁, 60₂, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 60₃, 60₄ sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Local devices 34 (e.g., user phone, user wearable, or user plug-in device) can be considered as sensors 60 as well, such as in embodiments in which the vehicle 10 uses data provided by the local device based on output of a local-device sensor(s). The vehicle system can use data from a user smartphone, for instance, indicating user-physiological data sensed by a biometric sensor of the phone.

The vehicle 10 also includes cabin output components 70, such as audio speakers 70₁, and an instruments panel or display 70₂. The output components may also include dash or center-stack display screen 70₃, a rear-view-mirror screen 70₄ (for displaying imaging from a vehicle aft/backup camera), and any vehicle visual display device 37.

### III. On-Board Computing Architecture—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media.

The storage can be referred to as a device, system, unit, the like, or other, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

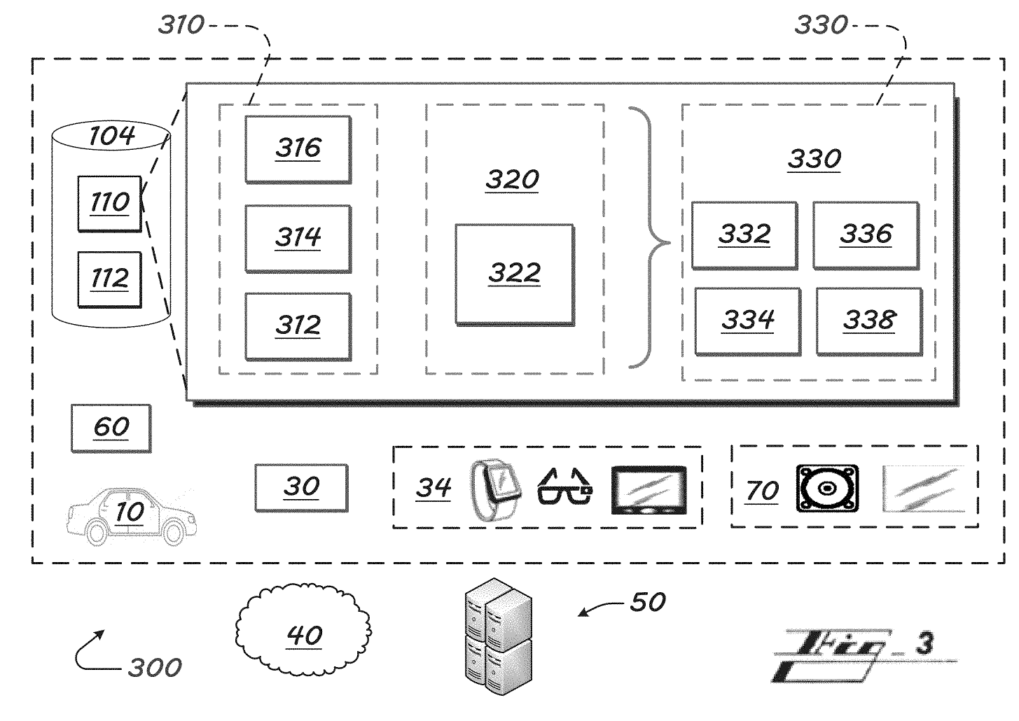

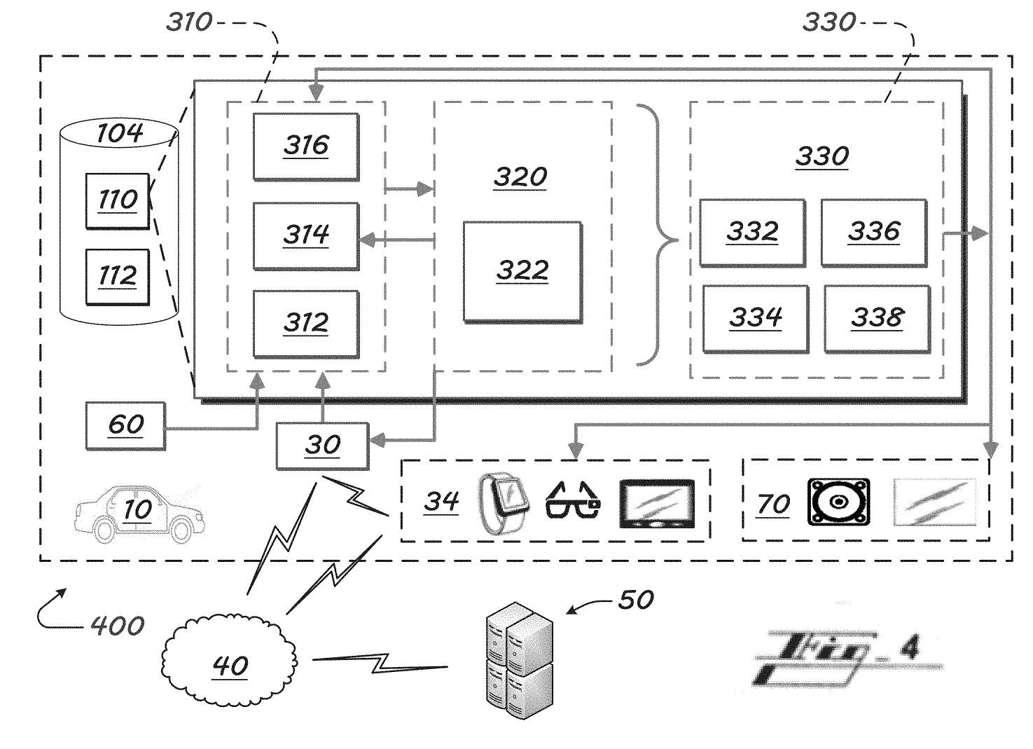

The data storage device 104 includes one or more storage components, units, or modules 110 storing computer-readable code or instructions executable by the processing unit 106 to perform the functions of the controller system 20 described herein. The modules and functions are described further below in connection with FIGS. 3 and 4.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a long-range network such as a satellite or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to, and in communication with, the vehicle.

Example remote systems 50 include a remote server, such as an application server. Another example remote system 50 includes a remote control center, data, center or customer-service center.

The user computing or electronic device 34, such as a smartphone, can also be remote to the vehicle 10, and in communication with the sub-system 30, such as by way of the Internet or another communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 60₄, such as radar or sonar, directed away from the vehicle, such as for supporting autonomous driving.

Visual-light cameras 60₃ directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 60₃ and the range sensor 60₄ may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 60₄ may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (60₁, 60₂, etc.) configured and arranged (e.g., positioned and fitted in the vehicle) to sense activity, people, cabin environmental conditions, or other features relating to the interior of the vehicle. Example cabin sensors (60₁, 60₂, etc.) include microphones, in-vehicle visual-light cameras, seat-weight sensors, user salinity, retina or other user characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 60₁, 60₂, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing user characteristics include any biometric or physiological sensor, such as a camera used for retina or other eye-feature recognition, facial recognition, or fingerprint recognition, a thermal sensor, a microphone used for voice or other user recognition, other types of user-identifying camera-based systems, a weight sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a microphone and speech recognition system, touch devices (e.g., a touch-sensitive display 37, buttons, and knobs), wearables, or any other hardware can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

### IV. Additional Vehicle Components—FIG. 3

FIG. 3 shows an alternative view of the vehicle 10 of FIGS. 1 and 2, emphasizing example memory components, and example associated devices.

As mentioned, the data storage device 104 includes one or more modules 110 for performing the processes of the present disclosure. and the device 104 may include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 shown include:
Input Group 310
   interface module 312;
   database module 314; and
   passenger-profile learning module 316;
Activity Group 320
   social HVAC manager agent 322; and
Output Group 330
   HVAC control module 332;
   ancillary climate-functions module 334;
   profile-update module 336; and
   notification module 338.

Other vehicle components shown in FIG. 3 include the vehicle communications sub-system 30 and the vehicle sensor sub-system 60. These sub-systems act at least in part as input sources to the modules 110, and particularly to the interface module 312.

Example inputs from the communications sub-system 30 include identification signals from portable devices, which can be used to identify or register a portable device, and so the corresponding user, to the vehicle 10, or at least preliminarily register the device/user to be followed by a higher-level registration.

The communication sub-system 30 receives and provides to the input group 310 data from any of a wide variety of sources, including sources separate from the vehicle 10, such as local devices 34, devices worn by pedestrians, other vehicle systems, local infrastructure (local beacons, cellular towers, etc.), satellite systems, and remote systems 34/50, providing any of a wide variety of information, such as user-identifying data, user-history data, user selections or user preferences, contextual data (weather, road conditions, navigation, etc.), program or system updates—remote systems can include, for instance, applications servers corresponding to application(s) operating at the vehicle 10 and any relevant user devices 34, computers of a user or supervisor (parent, work supervisor), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

Example inputs from the vehicle sensor sub-system 60 include and are not limited to:
bio-metric/physiological sensors providing bio-metric data regarding vehicle occupants, such as facial features, voice recognition, heartrate, salinity, skin or body temperature for each occupant, etc.;
vehicle-occupant input devices, such as vehicle human-machine interfaces (HMIs), such as a touch-sensitive screen, buttons, knobs, microphones, and the like;
cabin sensors providing data about characteristics within the vehicle, such as vehicle-interior temperature, in-seat weight sensors, and motion-detection sensors; and
environment sensors providing data about conditions about a vehicle, such as from external camera, distance sensors (e.g., LiDAR, radar), and temperature sensors.
vehicle-user interfaces/HMIs by which the vehicle can communicate with the users, and the users with the vehicle, such as a microphone and speech recognition system, touch devices (e.g., a touch-sensitive display 37, buttons, and knobs), wearables, or any other hardware can also be considered part of the sensor sub-system 60.

The view also shows example vehicle outputs 70, and user devices 34 that may be positioned in the vehicle 10. Outputs 70 include and are not limited to:
audio-output component, such as vehicle speakers;
visual-output component, such as vehicle screens;
vehicle-dynamics actuators, such as those affecting autonomous driving (vehicle brake, throttle, steering);
vehicle-climate actuators, such as those controlling HVAC system temperature, humidity, zone outputs, window position, sunroof position, and fan speed(s); and
local devices 34 and remote systems 34/50, to which the system may provide a wide variety of information, such as user-identifying data, user-biometric data, user-history data, contextual data (weather, road conditions, etc.), instructions or data for use in providing notifications, alerts, or messages to the user or relevant entities such as authorities, first responders, parents, an operator or owner of a subject vehicle 10, or a customer-service center system, such as of the OnStar® control center.

The modules, sub-modules, and their functions are described more below.

### V. Algorithms and Processes—FIG. 4

V.A. Introduction to the Algorithms

FIG. 4 shows an example algorithm, process, or routine represented schematically by a flow 400, according to embodiments of the present technology. The algorithms, processes, and routines are at times herein referred to collectively as processes or methods for simplicity.

Though a single process 400 flow is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 106, a processing unit of an user portable, and/or the unit of a remote device, executing computer-executable instructions stored on a non-transitory computer-readable storage device of the respective device, such as the data storage device 104 of the vehicle system 20.

The process can end or any one or more operations of the process can be performed again.

V.B. System Components and Functions

FIG. 4 shows the components of FIG. 3 interacting according to various exemplary algorithms and process flows.

The input group 310 includes the interface module 312, the database module 314, and the passenger-profile learning module 316.

Though all connections between modules is not shown expressly, input group modules interacts with each other in various ways to accomplish the functions of the present technology.

The interface module 312, executed by a processor such as the hardware-based processing unit 106, receives any of a wide variety of input data or signals, including from the sources described in the previous section (IV.), from the passenger, local devices 34, or remote devices or systems 50.

Inputs sources include vehicle sensors 60 and local or remote devices 34, 50, such as data storage components thereof, via the vehicle communication sub-system 30. Inputs also include a vehicle database, via the database module 304

Input data can include interior climate conditions, such as cabin temp and humidity, and exterior conditions, such as external temp and humidity.

In various embodiments, input data includes user profile data, from respective user profiles or accounts of autonomous vehicle service users, and any real-time requests from passengers, for change to vehicle climate, during a shared ride. Real-time requests can be received to the vehicle 10 in any of a variety of ways. In contemplated embodiments, real-time requests for change in climate, or changes or settings for vehicle functions that affect climate, such as rolling down the windows, turning down the temperature, or turning up an HVAC fan, can be received by a vehicle-user interface such as a vehicle microphone or touch-sensitive screen.

Real-time requests for change in climate, or changes or settings for vehicle functions that affect climate can also be received from user devices 34 whereby users cause the devices, or the devices automatically, communicate such requests in various embodiments. The user devices in these instances can include an application configured to facilitate provision of such input data. The application can be connected to or part of an autonomous-vehicle ride-share service application—e.g., a reservation program.

Real-time requests for change in climate, or changes or settings for vehicle functions that affect climate can also be received by user activity, or automatic-device action, such as by the user pressing a vehicle or mobile-device button to roll down a vehicle window, which would affect climate in the vehicle.

The user profile data can be stored locally, such as in the storage device 104, stored at a portable device, such as at a user smartphone or other user device 34, and/or remotely such as at a remoter server 50. Storage at any two or more devices can be synchronized, such as periodically, or in response to updates to the subject user profile at any of them.

A program or application at the user device 34 or the vehicle controller system 20 is in various embodiments configured to initiate performance of non-vehicle-operation functions of the present technology, such as initiating storing one or more user profiles, or data for the user profiles, at a cloud facility. The user device application can be part of or connected to an autonomous-vehicle shared-ride reservation application or program.

In various embodiments, each user profile includes (i) express climate preferences, communicated expressly by the user and/or (ii) learned climate preferences, determined by one of the systems described herein based on observations of the user and/or feedback from or other interaction with the user.

The user may provide preferences expressly in any of various ways, such as to a vehicle-passenger interface, to the user device 34, to a home laptop or computer, etc., before, during, or after a shared ride.

The receiving system (vehicle, user, device, etc.) can be configured to receive explicit communication from the user in any suitable manner. In various embodiments, this is done via system-presented menus, speech, gestures, typing, etc., and preferences can be learned by an automated system.

As mentioned, one or more of the systems described herein (vehicle system 20, portable device, etc.) is configured in various embodiments to learn preferences for a user.

The learning may be based, for instance, on sensed user behavior or actions, such as HVAC selections or a communication from the user indicating a preference directly or indirectly. Such communication or other input can be received at the subject system (vehicle, portable device, etc.) by way of any suitable modality (e.g., vehicle HMI, or phone HMI, smartwatch HMI, etc.) and user activity, such as speech, gestures, or selections by touch. The user input may include, for example, changing or inputting climate-control values, such as temperature or fan level, received via a button, switch, or touch screen interface of the vehicle or other device.

In various embodiments, each user profile includes learned climate preferences for a corresponding user. The passenger-profile learning module 316 may be configured to determine the profile based on interactions with the user over time. A user can have an expressly-preferred temperature, for instance, but the system may determine that when they are sharing an autonomous vehicle they are very flexible, and agreeable to variance, or perhaps even large variance, from their preferred temperature. While such flexibility can in some embodiments be communicated expressly by the user, in other embodiments the system can learn about the flexibility as mentioned, such as by noticing that the user does not request change to temperature, disapprove to temperature, or somehow behaves in a way indicating that they are fine with the new temperature. The system stores to the user profile data indicating the flexibility, or learned preference, as a quality, setting, or preference of the subject user.

The resulting profile can serve as an input to the activity group 320 and/or output group 330, such as via the database module 314 or the interface module 312.

Any preferences or profile data received or generated at the vehicle can be stored locally, such as via the database module 314, to the vehicle database 104. And the data can be synchronized or otherwise provided for storage at local or remote systems 34, 50.

By identifying each passenger riding in the vehicle 10, such as via a manifest of scheduled riders, or passengers, and mobile phone short-range signal (e.g., Bluetooth phone code share) identification, for instance, and having access to the profile data for each passenger riding in the vehicle 10, the vehicle 10, the system can determine a best group setting, or set of climate-related settings or parameters, based thereon, without requiring each passenger to communicate at the time their preferences to the vehicle 10, which would be cumbersome and inconvenient for the riders.

The profiles include individual comfort preferences pre-set by the respective passengers and/or learned via interactions with, or observations of, the user, such as preferred temperatures, fan speeds, humidity, window position, the like, other, and in some cases ranges for any of these.

The profiles in various embodiments also include pre-set values or data for compromise situations, and the values may include flexibility-related data. A user profile may indicate, for instance, that a user prefers a “solo-riding temperature” setting of 75 degrees Fahrenheit, for use when they are riding alone, but also indicates a “compromise temperature” setting, whether communicated expressly by the user or learned, indicating that they are comfortable with an increase up to 3 degrees and a decrease of up to 5 degrees, if needed to accommodate preferences of co-passengers on a shared ride.

Assume that a second user profile indicates a preferred temperature of 67 degrees Fahrenheit, and includes a compromise temperature setting indicating a flexibility to have an increase of 4 degree or decrease of 1 degree. The system may be configured to determine, assuming that just these two passengers are riding in the vehicle, a compromise temperature of 71, being between, and 4 degrees from the preferred temperature of each. The code can be configured in any desired manner to compromise amongst preferences of various users, such as by giving more weight to the preference of one of the users over the preference of another of the uses—i.e., the resulting compromise value need not in every case be a midway point between competing preferences.

Input-group data—user profile data indicating preferences, compromise settings, and any real-time requests for change, for instance—is passed on to the activity group 320, after any formatting, conversion, or other processing at the input group 310.

In various embodiments, the activity group 320 includes the social HVAC manager agent 322. The agent 322 can be referred to by other descriptive terms, such as HVAC module, HVAC manager, climate manager, climate-control module, vehicle-climate-manager, or the like.

During a shared ride, the social HVAC manager agent 322 of the vehicle, executed by the processing unit 106, determines a best or appropriate set of group climate control settings, based on the input received from the input module [e.g., user profile data indicating preferences, compromise settings, any real-time requests for change, interior climate conditions (e.g., cabin temp), exterior conditions (e.g., external temp and humidity)].

The social HVAC manager agent 322 determines the appropriate sole-passenger, or group, climate control settings in any of a variety of manners. For groups, the system may use average or mean of respective user preferences or desires communicated, which may be stored in respective user profiles, for a climate control variable, such as temperature.

In various embodiments, the social HVAC manager agent 322, based on the inputs, computes a group setting that will maximize riders' group comfort satisfaction in any suitable manner. The manner can include any implementation of any suitable coordination algorithm or conflict solving algorithm. Two example algorithms are:
i. Voting technique: The target temperature and fan levels in the vehicle are determined based on a vote, whereby each user contributes a vote for a certain variable, such as fan speed. The vote can be expressly provided by the user or from the user profile. Inputs might be received in a fuzzy manner. Example variable to vote on include temperature (high, medium, low temperature settings, or discrete temperature values), fan speed (high, medium, low), and air direction. For fan speed, for instance, the profiles of two passengers may prefer medium fan speed, while a third passenger's shows a preference for high fan speed. The system may be programmed to select the medium speed because more of the subject users ‘voted’ for medium speed.
ii. Weighted-sum technique: the system may be programmed so that each riders' contribution is not the same, such as by giving each user contribution a weight. The system may assign different authority based on price paid for a ride ticket, for instance, (e.g., premium rider level paid for instead of a standard level), and the higher-level riders preference may be multiplied by some weight or otherwise give more strength or sway in determining a value for the climate-related variable.

The output group 330 includes the HVAC control module 332, the ancillary climate-functions module 334, the profile-update module 336, and the user-notification module 338.

The modules of the output group in various embodiments formatting, conversion, or other processing desired on output of the activity module 320 prior to delivering same to the various output components.

As shown, example system output components include vehicle speakers, screens, or other vehicle outputs 70 by which the output group 330 implements the determined output.

Output is in various embodiments implemented by way of the vehicle systems, such as HVAC systems, via the HVAC control module 332, windows, moon/sun roof, seat heating/cooling functions, etc., via the ancillary climate-functions module 334, the like, or other.

The output group 330 in some embodiments, via the notification module 338, communicates determined outputs to the passenger(s). Example system output components can also include user devices 34, such as smartphones, wearables, and headphones. The notification module can also provide communications to other local and remote devices, such as a user portable device, autonomous-vehicle-fleet manager computer, user home laptop or desktop, shared-ride-service computer, etc.

Example system output components can also include remote systems 50 such as remote servers and user computer systems (e.g., home computer). The output can be received and processed at these systems, such as to update a user profile with a determined preference, activity taken regarding the user, the like, or other.

Example system output components, via the profile-update module 336, can also include a vehicle database. Output data can be provided to the database module 304, for instance, which can store such updates to an appropriate user account of the ancillary data 112, and can be selectively added to respective passenger profiles as appropriate. And the local database can be synchronized to local and remote apparatus 34, 50.

### VI. Additional Structure, Algorithm Features, and Operations

In combination with any of the other embodiments described herein, or instead of any embodiments, the present technology can include any structure or perform any functions as follows:

The technology in various embodiments includes systems and methods to control the climate control system in a shared autonomous vehicle.

In various implementations, the system includes methods to (1) get individual preferences from riders, (2) integrate individual requests into one group request from the actual climate control system and related systems (sunroof, windows, seats), (3) get real-time requested changes from individuals to the climate control system, (4) process these requests and compute a result to control the actual climate control system and related systems, (5) provide feedback to riders, and (6) update customers' social preferences models—e.g., flexibility or compromise settings.

The technology in various embodiments enables cooperation and coordination achievement in a shared ride arrangement. It can include a system that enables a group of riders to control the climate control as a group or, more particularly, a system that controls climate for the group based on various inputs described herein—e.g., user profile data indicating preferences, compromise settings, any real-time requests for change, interior climate conditions (e.g., cabin temp), exterior conditions (e.g., external temp and humidity).

The technology includes system and methods for providing coordinated climate control settings in a shared autonomous vehicle.

The technology includes an automated system and methods to compute a setting (or a series of settings) for the climate control system and related systems in the vehicle given the users' individual and social preferences.

The system is described primarily as being vehicle based, but can be performed primarily at another apparatus, such as remote server 50 or computing system of a shared-ride reservation system or customer-service system, such as of OnStar® or of an entity operating a fleet of shared autonomous vehicles.

The vehicle-based system is aware of users' profiles (for example might be downloaded from the cloud. These profiles include (1) preferences explicitly provided by the users or (2) preferences learned from previous interactions between the corresponding user and any vehicle in the fleet of shared autonomous vehicles).

These user's preferences comprise individual preferences and social preferences. For example, Tom prefers very cold temperatures but when he rides a social taxi, he is willing to compromise min 1 C or max 2 C from his own preferences.

Agent can either find a successful solution or decide that no possible solution exits that satisfies all riders. In such a case it should decide whether to find an average solution where there will be riders that are satisfied more than others or find a suboptimal solution where the majority might be very satisfied and some might be very not satisfied.

As another example:
1. Alice likes high temperatures (24 C) and lower fan levels (2);
2. Bob likes low temperatures (16 C) and medium fan levels (3-4);
3. Possible solution: medium temperature (21 C), propose that one of the passengers open the window, or system opens window directly, and set fan to level 2-3 (e.g., 2.5, or 3);
4. If Alice asks persistently (e.g., asks once, expressly, after having asked before or after her preference was known, such as by way of her profile) for higher temperatures, the system might need to ask for confirmation or approval from Bob for raising the temperature 22 C and up (and if he aggress, the system may update his profile to indicate the flexibility he agreed to under the circumstances);
5. If system identifies a conflict state, where no possible solution exists, and system in various embodiments can provide feedback to the riders advising them of the conflict, to invite flexibility, to advise them of a default setting to be used, to advise them that no further changes are being allowed, etc.;
6. In various embodiments, the system has access to user preferences before the ride is made, and possibly as part of the reservation process. The system may be programmed to advise a user having made a reservation that, based on the group reservation or manifest, there will or may be a conflict regarding vehicle climate settings, or to advise them of apparent limits, such as maximal changes that will be possible, based on individual and/or social preferences known. The system may recommend, or the user may on their own decide to reschedule, to get another group of co-riders, or to ride alone, so better climate settings can be had for the user. Or the system may be programmed to, before the ride or, as mentioned, during the ride, receive user input indicating flexibility or a change to a user setting, which may alleviate the perceived conflict.

Example functions representations:
1. GetIndividualProfile(ID)
2. GetSocialProfile(ID)
3. GetCurrClimateCtrlSettings
4. GetWindowStatus(ID)
5. GetSunRoofStatus
6. GetCabinTemp( )
7. GetExternalTemp( )
8. GetSolarLoad( )
9. GetCarOccupancy( )
10. GetChangeRequest(ID)
11. ComputeSocialChange( )
12. ImplementVotingMethod( )
13. ImplementWeightedIntegration( )
14. SetNewChange( )
15. SendUpdateTo(ID,modality)
16. UpdateSocialModel(ID)

The system is as mentioned configured to identify each passenger entering or having entered the vehicle 10. The vehicle associates passengers or potential passengers with any available corresponding profiles, such as those associated with a manifest or itinerary established via a reservation system. In embodiments in which a passenger profile is associated with any of the passengers, the vehicle system 20 obtains or accesses the corresponding profile(s). The profiles may include, for instance, passenger climate related preferences, which can include or be informed by history data indicating passenger's climate control choices from previous rides. The present technology can work even when one or more passenger profiles are not available. For instance, the system may use a default profile for any passenger, compute the group climate parameter(s) based on profiles for other passengers in the vehicle (e.g., for a bus scenario), and/or based on input (preferences inferred by speech, gestures, biometrics, and express selections or requests by touch, speech, gestures, etc.). An averaging computation may be used in any of these cases to determine a social HVAC solution for the multiple passengers riding in the vehicle.

In various embodiments, the determined group climate settings may include a differentiated solution, whereby various climate-affecting actions are taken in connection with various climate zones in the vehicle, and where various passengers are determined to be sitting. This can be done with our without identifying any of the passengers. For example, if a front passengers indicates that she would like warmer temperature, the vehicle associates the desire with her in-vehicle position; or if she was identified and associated with a passenger profile, the profile and its contents (preferences, etc.) are associated with her determined in-vehicle position. Passenger identification can be based, for instance, on biometric sensing, such as voice, camera, etc., user device communication (e.g., Bluetooth registration or signal). If the system determines that the passengers determined to be sitting in the front prefer warmer temperature, for instance, and third row passengers prefer cooler and breezy conditions, the system can determine to provide warmer air to the front row, and perhaps heat the seats a bit, while providing cooler air to the third-row zone, and possibly opening second- and/or third row windows and/or moonroof. For instances in which two zones are being differentiated, the implementation may be referred to as a dual-zone group, multi-zone or social, climate control. Example zone divisions include and are not limited to: (i) a split between left-focused and right-focused climate control system, or left- and right-focused climate control system components; (ii) a split between front-focused climate control system (e.g., driver and front passenger area) and one or more rear-focused climate control systems or components; (iii) a split between each of multiple rear-focused climate control systems or components (e.g., second row, and third row). The system determining the group, or social, climate settings, determines the various zone-focused climate outputs based on any of the input data described herein—such as available passenger profiles, passenger characteristics, behavior, or communications (speech, gestures, biometrics, selections, requests, etc.), cabin climate conditions, external climate conditions, current vehicle climate settings, including zone-specific settings (e.g., third row, left side fan speed, if available). Inputs from various passengers can be obtained or processed by the system generally simultaneously, or sequentially. Passenger input can be received at the same time, or sequentially, via common and/or distinct vehicle-user interfaces, and/or via user devices (e.g., user mobile phones).

In various embodiments, zone-specific HVAC averages, preferences, averages, or other values, can be determined for one or more vehicle zones, and then the zone-specific data may be used to determine an entire cabin, or all vehicle value.

As a simply example for purpose of illustration, it may be that two front occupants prefer or request temps of 73 and 71 degrees F. respectively, and that two rear occupants prefer temperatures of 80 and 82 F. The acting system may determine a front-of-cabin zone preference for 72 F, and a rear-zone preference of 81 F, and then an entire cab preference of 76.5 F.

As another example, it may be that two front occupants prefer or request temps of 73 and 71 respectively, and that two rear occupants are not associated in any of the systems with a temperature preference, but have a humidity preference. The acting system may determine a front-of-cabin zone preference for 72 degrees, and a rear-zone preference accommodating the rear-occupant humidity preferences or requests.

Thus, in various embodiments, the system can be configured, or operate, to, for determining how to actuate the physical HVAC components of the vehicle to affect cabin climate, consider (i) the entire cabin as a single zone, for which data regarding occupants in all portions is considered together, therein determining a single or set of way(s) of affecting the cabin by the HVAC components, (ii) consider the cabin as including multiple zones, therein determining ways—usually distinct ways—to affect each of the zones, or (iii) consider the cabin to include multiple zones associated with respective zone data, which zone data is used in turn to determine a single or set of way(s) of affecting the entire cabin by the HVAC components.

As described, in various embodiments, users interact, such as to provide system input, and in some cases to also receive communication from, through a user/vehicle or portable-device/user interface. The interface can include or be in communication with hardware, such as a display screen, microphone, speaker, button, knob, etc., allowing the user to input or receive system communication output. Based on any of the potential variables described herein (user preferences, from said passenger profiles, for instance, user selections, default settings, cabin climate, exterior climate. etc.), cabin climate is controlled by the acting system using the vehicle's HVAC, or climate-affecting, hardware or physical components—such as blower fans, heater core, thermostat, condenser, compressor, evaporator, etc.

For embodiments in which the HVAC system is configured to provide differentiated output to various zones of the vehicle, such as to maintain a front-row temperature at 73 F while maintaining a rear-row temperature of 78 F, the controller 20 may be configured to compromise on some settings, but not others. For instance, if, while front row passengers prefer a front-row temperature of 73 F while maintaining a rear-row temperature of 78 F, the front-row passengers prefer a high humidity level and the rear passengers prefer a relatively low humidity level, the controller 20 may be configured to control the physical HVAC components, or HVAC hardware, so that the front row is maintained at 73 F, the rear is maintained at 78 F, and the entire cabin is maintained at a medium humidity level. The system may determine this outcome because, for instance, the HVAC hardware may not be able to control output for humidity in zone-specific, zone-differentiated, manner.

In some implementations, the system determines whether to attempt to differentiate one or more HVAC output, regardless of whether the HVAC hardware is capable of providing zone-differentiated output.

The system may also partially differentiate zones. For instance, in the example above, the system may determine to maintain the front row at 74 F, and the rear row at 77 F, a bit higher and a bit lower than the front and rear passenger preference or request, respectively. This may done because doing so it is easier on the HVAC hardware system to maintain a smaller gap between climatic variables of adjacent or nearby intra-cabin zones. Or it may be that the HVAC hardware has limits under which it can only effect a certain level of differentiation—e.g., 3 F in this example, or can only effect a certain differentiation under current conditions, such as one or more of the windows being open.

Thus, in implementations, a resulting output need not be solely average of preferences or requests, but depending on the HVAC hardware and system programming, can provide each of two or more passengers their preferred or requested climate condition(s) possibly with a slight correction or adjustment, such as if the preference or request is very from that of an adjacent passenger.

### VII. Select Advantages

Many of the benefits and advantages of the present technology are described above. The present section restates some of those and references some others. The benefits described are not exhaustive of the benefits of the present technology.

The system improves user experience with shared autonomous-vehicle experiences by a coordination approach to consider all passenger preferences, and resolve gaps in preferences and attaining a social result in the experience.

The technology in operation enhances driver and/or passenger satisfaction, including comfort, with using automated driving by adjusting any of a wide variety of vehicle and/or non-vehicle characteristics, such as vehicle driving-style parameters.

The technology will lead to increased automated-driving system use. Users are more likely to use or learn about more-advanced autonomous-driving capabilities of the vehicle as well.

A ‘relationship’ between the user(s) and a subject vehicle can be improved—the user will consider the vehicle as more of a trusted tool, assistant, or friend.

The technology can also affect levels of adoption and, related, affect marketing and sales of autonomous-driving-capable vehicles. As users' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as they are set or adjusted automatically by the system, to minimize user stress and therein increase user satisfaction and comfort with the autonomous-driving vehicle and functionality.

### VIII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for controlling socially one or more autonomous-vehicle climate-affecting devices, comprising:
a hardware-based processing unit; and
a non-transitory computer-readable storage component comprising:
an interface module that, when executed by the hardware-based processing unit, obtains a ride-sharer passenger profile for each of multiple passengers of an autonomous vehicle;
a social vehicle-climate-manager module that, when executed by the hardware-based processing unit, determines group climate parameters for the autonomous vehicle based on the ride-sharer profiles; and
an output module that, when executed by the hardware-based processing unit, controls the autonomous-vehicle climate-affecting devices based on the group climate parameters determined.

2. The system of claim 1 wherein:
the autonomous-vehicle climate-affecting devices comprise a heating, ventilating, and air-conditioning (HVAC) module; and
the output module comprises an HVAC control module to control vehicle HVAC components.

3. The system of claim 1 wherein:
the autonomous-vehicle climate-affecting devices comprise an ancillary climate-functions device, not including a vehicle heating, ventilating, and air-conditioning (HVAC) apparatus; and
the output module comprises an ancillary climate-functions module to control ancillary vehicle device affecting vehicle climate, respectively.

4. The system of claim 1 wherein the interface module receives climate data, and the vehicle-climate-manager module is configured to, when executed by the hardware-based processing unit, determine the group climate parameters for the autonomous vehicle based on the ride-sharer profiles and the climate data.

5. The system of claim 4, wherein the climate data comprises an intra-vehicle climate condition or an exterior climate condition.

6. The system of claim 1 wherein the non-transitory computer-readable storage component comprises a passenger-profile learning module that, when executed, generates, based on user-behavior data, learned passenger-profile data regarding at least one passenger, and the ride-sharer profile corresponding to the at least one passenger includes the learned passenger-profile data corresponding to the at least one passenger.

7. The system of claim 1 wherein:
the interface module, when executed by the hardware-based processing unit, receives a real-time request to change vehicle climate settings from one of the passengers of the autonomous vehicle; and
the social vehicle-climate-manager module, when executed by the hardware-based processing unit, determines the group climate parameters for the autonomous vehicle based on the shared-ride profiles and the real-time request.

8. The system of claim 1 wherein the social vehicle-climate-manager module, when executed by the hardware-based processing unit, determines the group climate parameters for the autonomous vehicle based on the shared-ride profiles and the at least one additional factor selected from the group consisting of:
external temperature;
cabin temperature;
cabin humidity; and
solar load on the cabin environment.

9. The system of claim 1 wherein at least one of the shared-ride profiles comprises compromise parameters for use in determining the group climate parameters.

10. The system of claim 1 wherein:
the social vehicle-climate-manager module comprises a voting algorithm or a weighted-sum algorithm; and
the social vehicle-climate-manager module, when executed by the hardware-based processing unit, determines the group climate parameters for the autonomous vehicle using the voting algorithm or a weighted-sum algorithm.

11. The system of claim 1 wherein the interface module, when executed by the hardware-based processing unit, receives at least one of the shared-ride profiles from a remote server.

12. A system, for controlling one or more vehicle climate-affecting devices socially, comprising:
a hardware-based processing unit; and
a non-transitory computer-readable storage component comprising:
an interface module that, when executed by the hardware-based processing unit, obtains a ride-sharer passenger profile for each of multiple passengers of a vehicle;
a social vehicle-climate-manager module that, when executed by the hardware-based processing unit, determines group climate parameters for the vehicle based on the ride-sharer profiles; and
an output module that, when executed by the hardware-based processing unit, controls the vehicle climate-affecting devices based on the group climate parameters determined.

13. The system of claim 12 wherein:
the vehicle climate-affecting devices comprise a heating, ventilating, and air-conditioning (HVAC) module; and
the output module comprises an HVAC control module to control vehicle HVAC components.

14. The system of claim 12 wherein:
the vehicle climate-affecting devices comprise an ancillary climate-functions device, not including a vehicle heating, ventilating, and air-conditioning (HVAC) apparatus; and
the output module comprises an ancillary climate-functions module to control ancillary vehicle device affecting vehicle climate, respectively.

15. The system of claim 12 wherein the interface module receives climate data, and the vehicle-climate-manager module is configured to, when executed by the hardware-based processing unit, determine the group climate parameters for the vehicle based on the ride-sharer profiles and the climate data.

16. The system of claim 15, wherein the climate data comprises an intra-vehicle climate condition or an exterior climate condition.

17. The system of claim 12 wherein the non-transitory computer-readable storage component comprises a passenger-profile learning module that, when executed, generates, based on user-behavior data, learned passenger-profile data regarding at least one passenger, and the ride-sharer profile corresponding to the at least one passenger includes the learned passenger-profile data corresponding to the at least one passenger.

18. The system of claim 12 wherein:
the interface module, when executed by the hardware-based processing unit, receives a real-time request to change vehicle climate settings from one of the passengers of the vehicle; and
the social vehicle-climate-manager module, when executed by the hardware-based processing unit, determines the group climate parameters for the vehicle based on the shared-ride profiles and the real-time request.

19. The system of claim 12 wherein:
the social vehicle-climate-manager module comprises a voting algorithm or a weighted-sum algorithm; and
the social vehicle-climate-manager module, when executed by the hardware-based processing unit, determines the group climate parameters for the vehicle using the voting algorithm or a weighted-sum algorithm.

20. A non-transitory computer-readable storage component, for controlling one or more vehicle climate-affecting devices socially, comprising:
an interface module that, when executed by a hardware-based processing unit, obtains a ride-sharer passenger profile for each of multiple passengers of a vehicle;
a social vehicle-climate-manager module that, when executed by the hardware-based processing unit, determines group climate parameters for the vehicle based on the ride-sharer profiles; and
an output module that, when executed by the hardware-based processing unit, controls the vehicle climate-affecting devices based on the group climate parameters determined.
